(19) United States
(12) Patent Application Publication
(10) Pub. No.: US 2018/0312939 A1
(43) Pub. Date: Nov. 1, 2018

(54) COMPOSITIONS AND METHODS FOR SEPARATING IMMISCIBLE LIQUIDS

(71) Applicant: 3M INNOVATIVE PROPERTIES COMPANY, St. Paul, MN (US)

(72) Inventors: Michael J. Sierakowski, Stillwater, MN (US); Andrew W. Rabins, Saint Paul, MN (US); Karl D. Weilandt, Saint Paul, MN (US); Clinton P. Waller, Jr., White Bear Lake, MN (US); Mikhail A. Belkin, Minneapolis, MN (US); Susannah C. Clear, Hastings, MN (US); Tien Yi T.H. Whiting, Saint Paul, MN (US)

(73) Assignee: 3M INNOVATIVE PROPERTIES COMPANY, St. Paul, MN (US)

(21) Appl. No.: 15/770,060

(22) PCT Filed: Oct. 18, 2016
(86) PCT No.: PCT/US2016/057534

§ 371 Date: Apr. 20, 2018

Related U.S. Application Data
(60) Provisional application No. 62/243,797, filed on Oct. 20, 2015.

(51) Int. Cl. C22B 3/30; B01D 17/04; B01D 17/02; C22B 3/24

(52) U.S. Cl. CPC C22B 3/0017; C22B 3/24; B01D 17/0208; B01D 17/045

(57) ABSTRACT

Provided are methods and related compositions for separating immiscible organic and aqueous compositions. The methods include dispersing a discrete, insoluble filler in the organic composition, dispersing the organic composition into the aqueous composition, separating under gravity the organic and aqueous compositions into respective upper and lower layers. Advantageously, the insoluble filler remains in the organic composition and facilitates segregation and coalescence of droplets of the organic composition in the aqueous composition.

### FIELD OF THE INVENTION

Provided are methods for extracting a dispersed phase from a mixture of immiscible liquids, along with related compositions and apparatuses. These methods are relevant to, for example, solvent extraction methods used in a hydrometallurgical process.

### BACKGROUND

Separation of immiscible liquids is relevant to a wide range of industrial processes, and especially to liquid-liquid extraction systems. In liquid-liquid extraction, a desirable solute is transferred from a first liquid to a second liquid immiscible with the first liquid. Different solutes can have different relative solubilities in a given solvent, so this transfer can be used to separate co-dissolved solutes from each other. Liquid-liquid extraction is commonly used in the synthesis of organic compounds, refining of vegetable oils and petroleum products, ore reprocessing, nuclear reprocessing, along with many other industrial processes.

Multi-staged mixer-settlers are used in many large-scale operations. In each stage, a mixer thoroughly co-disperses immiscible phases, typically an organic solvent solution and an aqueous solution. These phases flow into a settler unit where phase separation occurs under gravity and the top layer is skimmed off. The cycle can be repeated by placing two or more mixer-settler units in tandem. Other extraction techniques include batchwise single stage extractions and centrifugal extractors.

Mixer-settlers are predominantly used in the industrial-scale hydrometallurgical production of elemental copper. The production process for copper can be generally divided into three major steps: (1) heap leaching, (2) organic solvent extraction, and (3) electrowinning.

Heap leaching is a known mining process for treating high and low grade copper ores. In this process, large amounts of mineral-bearing ore, such as crushed ore, are obtained from an open pit mine and piled into heaps over impervious leach pads. The copper ore is irrigated with a weak sulfuric acid solution to expose the metal in the ore to the leaching solution, extracting various minerals over a 30 to 90 day leaching cycle. The sulfuric acid is non-specific, and thus tends to also leach out unwanted minerals from the ore, such as iron and manganese. The solution readily dissolves copper in the ore to produce an aqueous “pregnant leach solution (PLS),” (i.e., a solution with dissolved valuable metals) that passes down through the ore pile and is collected from the leach pad.

The organic solvent extraction step provides for the isolation of copper ions from the metal-bearing PLS recovered from the heap leaching process above, and includes purification and strip stages. The purification stage generally takes place in a mixer-settler, where the PLS is mixed with a solvent extraction organic and the two phases allowed to separate. Copper ions transfer from the PLS to the solvent extraction organic through the formation of a copper complex that is soluble and stable in the organic phase. The now copper-loaded organic then separates from the copper-depleted aqueous phase (or “raffinate”), leaving the unwanted metal ions behind. The raffinate can then be recycled back into the leaching circuit.

In the strip stage, the copper-rich organic solution is advanced to another mixer-settler to strip the copper back into an aqueous solution called the electrolyte. Stripping involves mixing a strongly acidic solution with the loaded organic copper complex, which causes the complex to release its copper at the interface between the two phases. The complex takes on the acid so that the level of copper in the electrolyte increases and the acid level decreases as copper transfers out of the organic phase and is replaced by the acid.

Finally, in the electrowinning step, elemental copper is electrolytically plated onto cathodic blanks by reducing the copper ions from the electrolyte. After sufficient copper has been is plated onto the blanks, mechanical stripping of the plated electrode can be used to obtain high purity copper metal.

### SUMMARY

In the organic extraction step above, the time required for the organic and aqueous phases to separate from each other is known as the phase disengagement time (“PDT”). The PDT is an important criterion in a continuous solvent extraction process because the settler size is engineered to provide sufficient residence time for the two phases to disengage. If there is insufficient time for this to occur (i.e., the PDT exceeds the residence time), then excessive amounts of either aqueous-in-organic or organic-in-aqueous can be forwarded to the next process stage, resulting in a loss of efficiency. Slow phase disengagement may also require the operator to reduce flow rate through the settler, which reduces plant productivity.

Even when the PDT is within nominal ranges, the extraction organic can be lost in many ways, such as through evaporation, degradation, and entrainment. Entrainment is especially problematic when dealing with dispersions of very fine droplets, which tend to coalesce slowly. Any entrained organic in the electrolyte becomes exposed to oxidative conditions in the electrowinning tank that will eventually degrade it. Organic entrainment can be mitigated by using lower O/A (“organic-to-aqueous”) ratios but this also reduces the amount of copper complex that can be formed and hence overall yield. Aqueous entrainment also presents a problem, since such entrainment can impact current efficiency of the electrowinning operation and the product quality of the finished copper cathode.

In conventional operations, the flow rate and relative amounts of organic and aqueous compositions are adjusted to balance efficiency, overall throughput, and product quality. Nonetheless, aqueous entrainment levels typically to fall in the range of about 20-100 ppm based on a settler flux of 5-6 m³/m²/hour, with organic entrainment levels in a similar range. Progressive improvements have been made in solvent extraction circuits, mixer-settler configurations, extraction reagents, and diluents, but extraction organic loss remains one of the most significant sources of operation costs to the mining operation. Even with entrainment levels on the order of about 20 to 40 parts per million, the financial impact over the course of a one-year operation can be in excess of several million dollars.

The provided methods and compositions represent a solution to the aforementioned problem of extraction organic entrainment that involves adding small amounts of discrete filler, such as chopped polymeric fiber, to the extraction organic phase. This was found to substantially facilitate the coalescence and removal of a dispersed phase from a continuous phase, and even enable O/A ratios not previously practicable because of entrainment issues.

In one aspect, a method of separating immiscible organic and aqueous compositions is provided. The method comprises: dispersing a discrete, insoluble filler in the organic composition; dispersing the organic composition into the aqueous composition; and separating under gravity the organic and aqueous compositions into respective upper and lower layers, wherein the insoluble filler remains in the organic composition and facilitates segregation and coalescence of droplets of the organic composition in the aqueous composition.

In another aspect, a hydrometallurgical method is provided, comprising: placing an acid or base in contact with a mineral bearing ore to obtain a pregnant leach solution; mixing a solvent extraction organic with the pregnant leach solution to provide an organic composition dispersed in an aqueous composition, respectively; separating the organic and aqueous compositions using the aforementioned method to provide a loaded organic composition; and contacting the loaded organic composition with a stripping solution to remove metal ions from the loaded organic composition.

In still another aspect, an extraction composition is provided, comprising: an organic composition comprising an extractant; and a discrete filler dispersed in the organic composition.

In yet another aspect, a solvent extraction apparatus is provided, comprising: a mixing tank with the aforementioned extraction composition received therein, the mixing tank provided with an impeller to agitate the extraction composition; and a settling basin in communication with the mixing tank and comprising an inlet to receive the extraction composition from the mixing tank and an outlet.

### BRIEF DESCRIPTION OF THE DRAWINGS

FIG. 1 is a schematic showing an exemplary copper hydrometallurgical process;

FIG. 2 is a schematic showing the formation of a copper complex by an exemplary solvent extraction organic in a copper hydrometallurgical process;

FIGS. 3A and 3B are schematics showing entrainment in the coalescence of aqueous-continuous and organic-continuous mixtures;

FIG. 4 is a schematic showing the action of porous structures in assisting the coalescence of liquid droplets;

FIG. 5 is a scanning electron micrograph showing chopped staple fibers for dispersion in a solvent extraction organic.

### DEFINITIONS

As used herein:

“ambient conditions” means at a temperature of 25° C. and pressure of 101.3 kilopascals.

### DETAILED DESCRIPTION

The following sections describe, by way of illustration and example, various methods, compositions, and apparatuses relating to the phase separation of immiscible liquids. A primary application for these methods, compositions, and apparatuses is in the industrial scale hydrometallurgical production of copper metal. Yet it is understood that other applications may exist, for example, in the production or purification of zinc, uranium, silver, or gold by aqueous means. Even more broadly, this disclosure may be applied to other diverse industrial technologies, including the production of biofuels and chemicals, removal of organics from wastewater, acetic acid extraction, essential oil extractions, caprolactam extraction, and neutralization/washing of acids or bases from an organic stream.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### Copper Hydrometallurgical Process

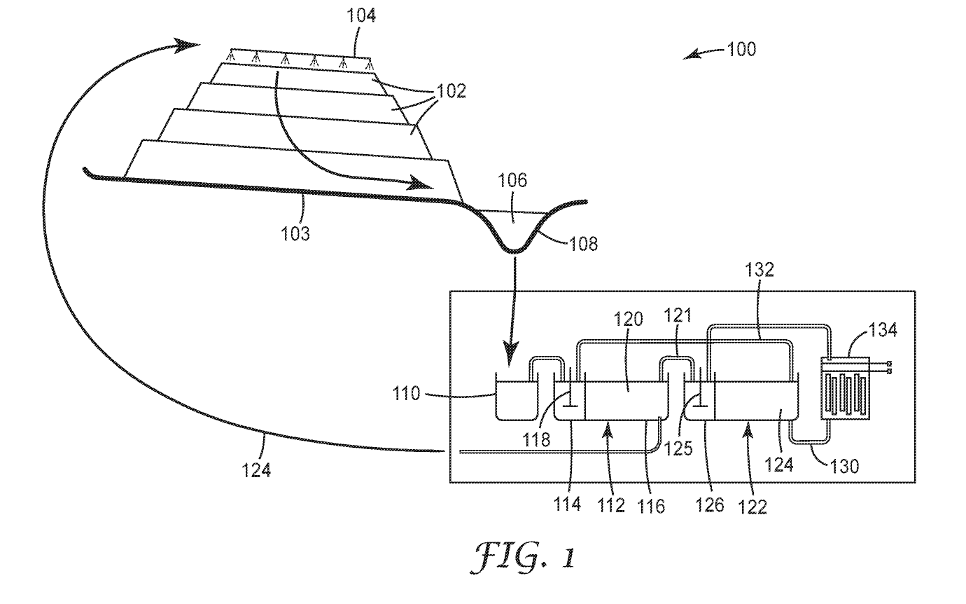

An exemplary copper heap leaching process is depicted in FIG. 1 and herein designated by the numeral 100. In this figure, mined oxide ore is loaded as a series of layers 102, also known as heaps, on an impervious pad 103. Dilute sulfuric acid is introduced to the fresh ore using sprayers 104 that distribute the acid evenly over the ore. Optionally, additional mined ore can be stacked on top of existing heaps. As the acid flows over and through the ore, it dissolves the copper to provide a pregnant leach solution that flows along an incline in the pad 103 into a collection ditch 108, or alternatively a dammed reservoir, located downstream from the leach area.

The acidity of the dilute sulfuric acid is not particularly restricted. Preferably, however, the acid is sufficient to obtain from the given ore a pregnant leach solution with a copper ion concentration of at least 1 gram per liter, at least 1.5 grams per liter, or at least 2 grams per liter of sulfuric acid. On the upper end, it is preferable for the pregnant leach solution to have a copper ion concentration of up to 35 grams per liter, up to 20 grams per liter, or up to 10 grams per liter.

Referring again to FIG. 1, leachate 106 from the collection ditch 108 is then conveyed into a storage vessel 110 and metered into a mixer settler 112 comprised of a baffled mixing tank 114 and an elongated settler 116. In the mixing tank 114, the leachate 106 is combined with an organic composition immiscible with the leachate 106 and thoroughly mixed by an impeller 118 or other mixing device. The mixture of leachate, or aqueous composition, and organic composition is defined as extraction composition 120.

As used herein, “extraction composition” broadly encompasses compositions that may be useful in extraction and/or stripping operations in a hydrometallurgical process. Particulars of the provided extraction compositions shall be described in a forthcoming section.

In the context of the provided hydrometallurgical methods, the extraction composition 120 contains an active organic component capable of forming a stable chemical complex with the copper ions in the leachate 106. This can be expressed, for example, by the following chemical reaction:

Cu++ (aq)+2RH (org) [symbol] R₂Cu (org)+2H+ (aq)

where Cu++ (aq) is copper in the leachate, RH (org) is an extractant, R₂Cu (org) is the copper/extractant (i.e., loaded organic), and H+ (aq) is the acid in raffinate solution.

Complex formation, also known as chelation, occurs when the leachate comes into contact with the extractant in the organic component. This process is accelerated by the rapid creation of interfacial surfaces during the mixing process. Freshly mixed, the extraction composition 120 then flows to the settling basin 116, where it phase separates under gravity to provide discrete layers of organic and aqueous phases. Being soluble in the organic phase, the copper complex tends to segregate in that phase, which floats above the copper-depleted aqueous phase, or raffinate.

In the provided methods, a suitable balance between extraction efficiency and throughput in an industrial process can be achieved when the organic and aqueous phases display a phase disengagement time of at least 30 seconds, at least 35 seconds, at least 40 seconds, at least 50 seconds, or at least 60 seconds, under ambient conditions. In a preferred embodiment, the organic and aqueous phases display a phase disengagement time of up to 120 seconds, up to 110 seconds, up to 100 seconds, up to 95 seconds, or up to 90 seconds, under ambient conditions.

As the extraction composition 120 approaches the end of the settling basin 116, the segregated organic phase is discharged through a first outlet 121 to a second mixer-settler 122, while the raffinate is recycled via a second outlet 124 back into the leaching circuit. Optionally but not shown here, one or more baffles that extend vertically from above or below into the settling basin 116 can further assist in separating the organic phase and raffinate from each other.

In the second mixer-settler 122, the copper-rich organic phase is “stripped” out by placing it in contact with an electrolyte. This can be represented by essentially the reverse of the chemical reaction above:

R2Cu (org)+2H+ (aq) [symbol] Cu++ (aq)+2RH (org)

where R₂Cu (org) is the copper/extractant (i.e., loaded organic), H+ (aq) is the acid in the electrolyte, Cu++ (aq) is copper in the electrolyte solution, and RH (org) is the stripped copper complex.

The electrolyte for copper production is a highly acidic solution such as a concentrated sulfuric acid. In some embodiments, the concentrated sulfuric acid has a concentration of at least 50 grams per liter, at least 100 grams per liter, or at least 150 grams per liter. In some embodiments, the concentrated sulfuric acid has a concentration of up to 300 grams per liter, up to 250 grams per liter, or up to 200 grams per liter. This mixture, referred to as stripping composition 124 in FIG. 1, is agitated by a second impeller 125 in a second mixing tank 126 to form a fine, two-phase dispersion.

As before, the copper ions are transferred from one phase to the other—this time from the organic phase back into the aqueous phase. The loaded copper complex takes on the acid and releases its copper into the electrolyte. After coalescing in a second settling basin 128, the loaded electrolyte is conveyed through outlet 130 to an electrowinning cell 134. The copper-depleted organic composition can then be recycled as shown back into the first mixing tank 114 for reuse in the extraction of the leachate 106.

In the electrowinning cell 134, hard bright copper is electrolytically plated onto cathode blanks. These cathodes are allowed to grow to a suitable size, and are then mechanically stripped to harvest the plated copper metal.

### Extraction Compositions

As generally described above, the extraction composition 120 contains a liquid organic composition and a liquid aqueous composition that is immiscible with the organic composition.

The organic composition includes one or more discrete fillers dispersed in the liquid. The discrete filler may comprise fibers, spherical particles, plate-like particles, or combinations thereof that are generally insoluble in the organic composition. Advantageously, these fillers are free-flowing; that is, they can migrate within the organic composition without being confined to a particular location or structure within the extraction and/or stripping process. Preferably, the discrete filler is comprised of discrete fibers. More preferably, the discrete fibers are chopped polymeric fibers.

In preferred embodiments, the filler has a surface chemistry allowing it to preferentially wet, and segregate in, the organic composition. As such, it need not be pre-dispersed in the organic composition prior to mixing the organic and aqueous compositions. Instead, for example, the filler could be dispersed in the extraction composition after the two components are mixed, or even pre-dispersed in the aqueous composition prior to mixing. For convenience to the user, the filler may advantageously be provided pre-dispersed in a single component of the organic composition by a manufacturer then subsequently mixed during the hydrometallurgical process.

The filler preferably remains in the organic phase during the mixing and settling of the mutually immiscible organic and aqueous compositions. It is conceivable, however, that the filler may eventually “settle out” of the organic composition over time, while still assisting in the early stages of coalescing minority phase droplets in the extraction composition.

The polymeric fibers, or filler more generally, can be present in the organic composition in an amount of at least 0.05 percent, at least 0.06 percent, at least 0.07 percent, at least 0.08 percent, or at least 0.1 percent. The polymeric fibers (or filler more generally) can be present in an amount of up to 2 percent, up to 1.5 percent, up to 1 percent, up to 0.75 percent, or up to 0.5 percent.

Where a polymeric filler is used, the filler can be made from any polymer compatible with the remaining components of the organic composition. For example, suitable polymers include polyesters, nylon, polyolefins (such as polypropylene, polyethylene, and 4-methylpentene-1 based polyolefin), and copolymers and blends thereof. Polymeric fillers may also include those made from naturally occurring polymers, such as silk, wool, and cellulose. FIG. 5 shows a scanning electron micrograph of exemplary polyester fibers having a nominal diameter of 30 microns.

Chopped fiber can be made using any known method. One exemplary method begins with producing fibers on a continuous fiber spinning line that consists of one or more single-screw extruders, a radiantly heated compartment, a plurality of draw zones, and a winder. A hundred or more fibers can be produced on a tow simultaneously using this configuration by extruding them through respective orifices in a melt spinning die.

In cases where the discrete filler is fibrous, the fibers can have a mean diameter of at least 1 micrometer, at least 2 micrometers, at least 3 micrometers, at least 4 micrometers, or at least 5 micrometers. In some embodiments, the fibers have a mean diameter of up to 100 micrometers, up to 75 micrometers, up to 50 micrometers, up to 40 micrometers, or up to 30 micrometers.

Useful fiber fillers for the organic composition can have a median aspect ratio of at least 5, at least 10, at least 20, at least 35, at least 50, at least 80, at least 100, at least 150, at least 200, at least 225, or at least 250. Such fiber fillers could also have a median aspect ratio of up to 600, up to 700, up to 800, up to 900, or up to 1000.

Suitable lengths for the fiber fillers, like diameters, are not especially critical but should have dimensions that facilitate distributive mixing and prevent excessive agglomeration when dispersed within the organic composition. In some embodiments, the fibers have a median length of at least 100 micrometers, at least 250 micrometers, at least 500 micrometers, at least 750 micrometers, or at least 1000 micrometers. In some embodiments, the fibers have a median length of up to 10000 micrometers, at least 7500 micrometers, at least 5000 micrometers, at least 4000 micrometers, or at least 3000 micrometers.

The filler density need not be particularly restricted but preferably has a density with some degree of buoyancy enabling the filler to be easily dispersed, and remain dispersed, in the organic composition. The filler density can be at least 0.5 g/cm³, at least 0.55 g/cm³, or at least 0.6 g/cm³.

The filler density can be up to 2.5 g/cm³, up to 2.2 g/cm³, up to 2.0 g/cm³, up to 1.8 g/cm³, or up to 1.5 g/cm³.

Preferred fillers are compatible with the organic composition and capable of being wetted by the organic composition. To enhance compatibility with the remaining components of the organic composition, the filler may be surface functionalized or otherwise coated with an additive to promote wetting. Such surface functionalization can be imparted, for example, by corona treatment, plasma treatment, or flame treatment of the fibers prior to being chopped. None of the above, however, precludes the possibility that the filler may also be compatible with, and capable of wetting, the aqueous composition.

With respect to chopped polymeric fiber, it can be advantageous to produce bi-component fibers by using two or more extruders to feed different polymeric resins into a melt spinning die. Such bi-component fibers can have a shell made from a first polymer disposed around a core of a second polymer.

Preferably, the dispersion of filler into the organic composition provides a suspension that is substantially stable—that is, a suspension that does not settle under gravity over typical time scales used in the extraction or stripping process.

The liquid components of the organic composition generally include a carrier solvent, such as an aliphatic hydrocarbon, aromatic hydrocarbon, or mixture thereof. Useful aliphatic hydrocarbons may contain paraffin (sometimes referred to as kerosene), cycloparaffin, or derivatives of the same. One exemplary carrier solvent, for example, is a paraffin-based solvent known by its trade designation ORFOM SX 80, provided by Chevron-Phillips Chemical Company, The Woodlands, Tex.

Dispersed or dissolved in the liquid component(s) of the organic composition is an extractant. Preferred extractants are oxime-based extractants. The oxime-based extractant can derive from a ketoxime, aldoxime, or mixture thereof. Preferred ketoximes have the chemical structure:

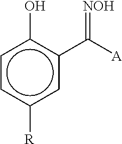

wherein A is selected from C₆H₅ and CH₃ and R is selected from C₁₂H₂₅ and C₉H₁₉.

These ketoximes are sometimes referred to by the trade designations LIX 65, LIX 65N, LIX 84-I, and SME 529 by providers such as BASF SE, Ludwigshafen, Germany.

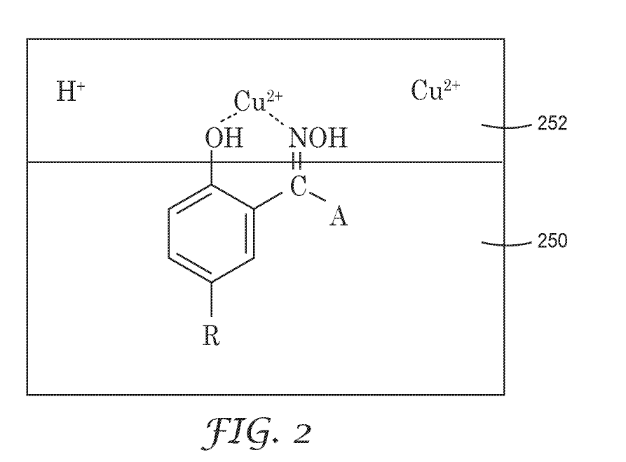

Advantageously, these ketoximes can perform as very specific extractants for copper ions within a certain Cu²⁺ concentration and pH range. FIG. 2 illustrates chelation (i.e., chemical binding) between a Cu²⁺ ion and a ketoxime under favorable conditions at the interface between an immiscible organic phase 250 and aqueous phase 252.

Aldoximes are known to form similar complexes with copper in a biphasic solvent extraction systems. Preferred aldoximes have the chemical structure:

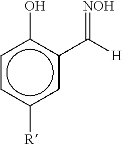

wherein R′ is selected from C₁₂H₂₅ and C₉H₁₉.

These aldoximes are sometimes referred to by the trade designations LIX 860-I, LIX 622, P1, and LIX 860N-I by providers such as BASF SE, Ludwigshafen, Germany. Aldoxime-based extractants tend to bind to the copper quite strongly and thus can require a very high concentration of acid in the electrolyte in order to obtain efficient stripping. To overcome this problem, the aldoxime can be modified by the addition of a long chain modifier, such as long-chain alcohol.

The oxime-based extractant can be present in an amount of at least 1 percent, at least 2 percent, at least 5 percent, at least 7 percent, or at least 10 percent by weight based on the overall weight of the organic composition. In exemplary embodiments, the oxime-based extractant can be present in an amount up to 30 percent, up to 28 percent, up to 25 percent, up to 22 percent, or up to 20 percent by weight based on the overall weight of the organic composition.

The aqueous composition of the extraction composition is generally the leachate obtained from percolation through the mined ore. In copper production, the aqueous composition is generally a sulfuric acid solution. This sulfuric acid solution can be have a pH of at least 1.1, at least 1.2, at least 1.4, at least 1.5, at least 1.6, up to 2.5, up to 2.2, up to 2, up to 1.9, or up to 1.8.

When mixed with each other, the organic and aqueous compositions form an unstable emulsion that gradually phase separates, or disengages, as a result of the organic and aqueous compositions being immiscible. Since the organic phase has a lower density than the aqueous phase, it tends to float to the top while the aqueous phase sinks to the bottom.

Depending on the relative amounts of organic and aqueous phases present in the extraction composition, the resulting emulsion can be either organic continuous (with droplets of aqueous composition dispersed in organic composition) or aqueous continuous (with droplets of organic composition dispersed in aqueous composition). These are also known in the art as “water-in-oil” and “oil-in-water” emulsions, respectively. The critical amount where one type of emulsion converts to the other typically depends on the relative volume of each phase in the mixer. If there is more organic composition than aqueous composition, then the mix will be organic continuous, and vice versa.

The distinction between organic continuous and aqueous continuous emulsions is important because it has bearing on the problem of entrainment. Organic continuous emulsions generally produce aqueous phases that are low in organic entrainment, while aqueous continuous emulsions produce organic phases that are low in aqueous entrainment.

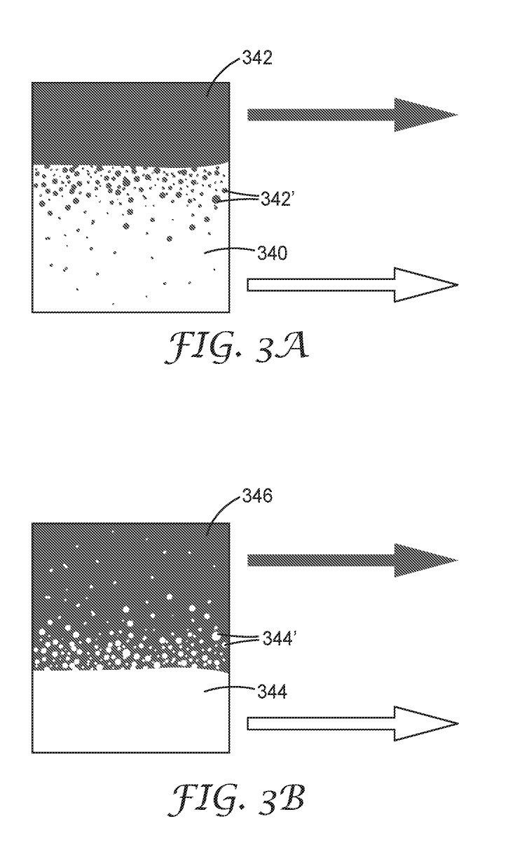

FIGS. 3A and 3B illustrate the above observation. In FIG. 3A, the aqueous phase 340 is the minority phase and hence continuous when mixed with the organic phase 342. Upon separation, there is still significant entrained organic phase 342′ in the bottom, aqueous phase 340. As shown, however, there is comparatively very little aqueous phase entrained in the upper, organic phase 342. In FIG. 3B, the opposite is the case; the organic phase 346 is the majority phase, resulting in significant entrained aqueous phase 344′ entrained in the organic phase 346 and relatively little organic entrainment in the aqueous phase 344.

In copper hydrometallurgy, the extraction composition is generally an oil-in-water emulsion. The relative ratios of the organic and aqueous components need not be particularly restricted. Preferably, however, the organic composition is dispersed in the aqueous composition at an organic:aqueous (“O/A”) ratio of at least 0.2:1, at least 0.7:1, at least 0.8:1, at least 0.85:1, or at least 0.9:1 by volume under ambient conditions. In some or all embodiments, the organic and aqueous compositions can be present in an O/A ratio of up to 1:1 by volume under ambient conditions.

The addition of even small amounts of a discrete filler, such as a chopped polymeric fiber, can significantly affect the viscosity of the extraction composition in its emulsified state. Without wishing to be bound by theory, it is believed that the dispersed fibers interact with the minority phase droplets to form an in situ network along the developing organic/aqueous phase boundary that facilitates the segregation and coalescence of fine organic droplets that would otherwise remain entrained in the aqueous phase. It was further discovered that the presence of dispersed fibers can also facilitate the segregation and coalescence of aqueous droplets in the organic phase. Filler addition may also result in an overall increase in average droplet size after mixing. Both effects could be related to the observed increase in emulsion viscosity.

The inclusion of a discrete filler into the organic phase of the extraction composition provides a number of significant technical advantages as described below.

First, the inclusion of the fillers can significantly reduce the level of organic entrainment in the continuous aqueous phase. The presence of discrete filler, for example, can reduce entrainment of the organic composition in the aqueous composition by at least 10 percent, at least 20 percent, at least 30 percent, at least 50 percent, or at least 60 percent relative to that obtained in absence of the discrete filler under ambient conditions. While the absolute level of entrainment depends on many other factors, the provided methods are capable of providing an equilibrium organic composition entrainment in the aqueous composition of up to 1000 ppm, up to 500 ppm, up to 300 ppm, up to 100 ppm, up to 50 ppm, up to 30 ppm, up to 20 ppm, or up to 10 ppm.

This reduction in entrainment can be visually manifested by a decrease in turbidity. For example, use of polymeric fibers can reduce turbidity of the aqueous composition associated with entrained organic composition by at least 10 percent, at least 20 percent, at least 30 percent, at least 50 percent, or at least 60 percent, relative to that observed in absence of the discrete filler under ambient conditions. Turbidity, as referred to here, can be measured in Nephelometric Turbidity Units (“NTU”) using commercially available turbidimeters such as those available from Hanna Instruments, Woonsocket, R.I.

Second, the addition of fillers can also reduce entrainment of aqueous phase in the continuous organic phase. Separating the organic and aqueous compositions has been observed to reduce entrained aqueous composition in the organic composition to amounts of up to 1000 ppm, up to 500 ppm, up to 300 ppm, up to 200 ppm, up to 100 ppm, up to 75 ppm, up to 50 ppm, or up to 40 ppm.

Third, and just as significantly, the provided methods afford the possibility of operating a mining operation at higher O/A ratios previously not achievable as a result of process constraints related to entrainment. The O/A ratio currently used in copper production tends to be skewed to minimize entrainment. Increasing the O/A ratio closer to a 1:1 volume ratio in the mixer settler enables a higher flow rate of loaded organic into the stripping and electrowinning processes, and as a result increased throughput in a copper production process.

Further improvements to the mixer-settler (such as the mixer-settlers 112, 122) are possible. For instance, a picket fence system can be disposed in the settler basin to facilitate coalescence of the organic/aqueous emulsion by passing it through one or more porous structures.

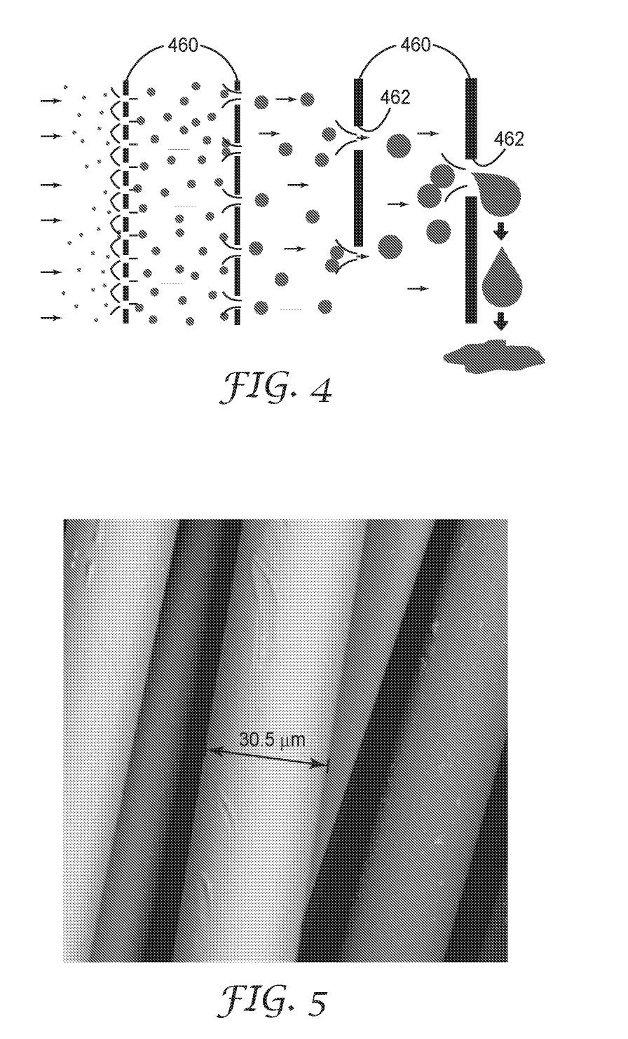

As shown schematically in FIG. 4, porous structures 460 act as coalescing media that guide droplets of the discontinuous organic phase into contact with each other as they pass through apertures 462 having sizes on the order of the prevailing droplet size. In a preferred embodiment, the porous structure 460 become progressively larger toward the downstream direction as smaller droplets coalesce into increasingly larger ones.

While not intended to be exhaustive, particular embodiments of useful methods, compositions, and apparatuses are enumerated as follows:

### Embodiment 1

A method of separating immiscible organic and aqueous compositions, the method comprising: dispersing a discrete, insoluble filler in the organic composition; dispersing the organic composition into the aqueous composition; and separating under gravity the organic and aqueous compositions into respective upper and lower layers, wherein the insoluble filler remains in the organic composition and facilitates segregation and coalescence of droplets of the organic composition in the aqueous composition.

### Embodiment 2

The method of embodiment 1, wherein dispersing the organic composition into the aqueous composition causes droplets of the organic composition to be dispersed in a continuous phase of the aqueous composition.

### Embodiment 3

The method of embodiment 1 or 2, wherein the discrete filler comprises polymeric fibers.

### Embodiment 4

The method of embodiment 3, wherein the polymeric fibers are present in the organic composition in an amount of from 0.05 percent to 2 percent by weight based on the weight of the organic composition.

### Embodiment 5

The method of embodiment 4, wherein the polymeric fibers are present in the organic composition in an amount of from 0.1 percent to 1 percent by weight based on the weight of the organic composition.

### Embodiment 6

The method of embodiment 5, wherein the polymeric fibers are present in the organic composition in an amount of from 0.1 percent to 0.5 percent by weight based on the weight of the organic composition.

### Embodiment 7

The method of any one of embodiments 3-6, wherein the polymeric fibers have a median diameter of from 1 micrometer to 100 micrometers.

### Embodiment 8

The method of embodiment 7, wherein the polymeric fibers have a median diameter of from 3 micrometers to 50 micrometers.

### Embodiment 9

The method of embodiment 8, wherein the polymeric fibers have a median diameter of from 5 micrometers to 30 micrometers.

### Embodiment 10

The method of any one of embodiments 3-9, wherein the polymeric fibers have a median aspect ratio of from 80 to 1000.

### Embodiment 11

The method of embodiment 10, wherein the polymeric fibers have a median aspect ratio of from 250 to 600.

### Embodiment 12

The method of any one of embodiments 3-11, wherein the polymeric fibers comprise polyester fibers.

### Embodiment 13

The method of any one of embodiments 3-12, wherein the polymeric fibers comprise nylon fibers.

### Embodiment 14

The method of any one of embodiments 3-13, wherein the polymeric fibers comprise polyolefin fibers.

### Embodiment 15

The method of embodiment 14, wherein the polyolefin fibers comprise polyethylene fibers.

### Embodiment 16

The method of any one of embodiments 2-15, wherein the organic composition is a solvent extraction organic for a hydrometallurgical process.

### Embodiment 17

The method of embodiment 16, wherein the solvent extraction organic comprises an oxime-based extractant dissolved in a carrier solvent.

### Embodiment 18

The method of embodiment 17, wherein the oxime-based extractant comprises a ketoxime.

### Embodiment 19

The method of embodiment 17 or 18, wherein the carrier solvent comprises an aliphatic hydrocarbon, aromatic hydrocarbon, or mixture thereof.

### Embodiment 20

The method of any one of embodiments 1-19, wherein the discrete filler forms a suspension within the organic composition that is substantially stable.

### Embodiment 21

The method of any one of embodiments 1-20, wherein the discrete filler has a density of from 0.5 g/cm³ to 2.5 g/cm³.

### Embodiment 22

The method of embodiment 21, wherein the discrete filler has a density of from 0.6 g/cm³ to 2.0 g/cm³.

### Embodiment 23

The method of embodiment 22, wherein the discrete filler has a density of from 0.6 g/cm³ to 1.5 g/cm³.

### Embodiment 24

The method of any one of embodiments 1-23, wherein the insoluble filler facilitates segregation and coalescence of droplets of the aqueous composition in the organic composition.

### Embodiment 25

The method of any one of embodiments 1-24, wherein the addition of the insoluble filler provides an overall increase in average droplet size after mixing relative to the average droplet size observed when the insoluble filler is absent.

### Embodiment 26

The method of any one of embodiments 1-25, wherein the addition of the insoluble filler increases the viscosity of the dispersion relative to the viscosity observed when the insoluble filler is absent.

### Embodiment 27

The method of any one of embodiments 1-26, wherein the aqueous composition is a sulfuric acid solution.

### Embodiment 28

The method of embodiment 27, wherein the sulfuric acid solution comprises copper ions present at a concentration of from 1 gram per liter to 35 grams per liter.

### Embodiment 29

The method of embodiment 28, wherein the sulfuric acid solution comprises copper ions present at a concentration of from 1.5 grams per liter to 20 grams per liter.

### Embodiment 30

The method of embodiment 29, wherein the sulfuric acid solution comprises copper ions present at a concentration of from 2 grams per liter to 10 grams per liter.

### Embodiment 31

The method of any one of embodiments 1-30, wherein the organic and aqueous compositions are present in an organic:aqueous ratio of from 0.2:1 to 1:1 by volume.

### Embodiment 32

The method of embodiment 31, wherein the organic and aqueous compositions are present in an organic:aqueous ratio of from 0.7:1 to 1:1 by volume.

### Embodiment 33

The method of embodiment 32, wherein the organic and aqueous compositions are present in an organic:aqueous ratio of from 0.9:1 to 1:1 by volume.

### Embodiment 34

The method of any one of embodiments 1-33, wherein the organic and aqueous compositions display a phase disengagement time of from 30 seconds to 120 seconds under ambient conditions.

### Embodiment 35

The method of embodiment 34, wherein the organic and aqueous compositions display a phase disengagement time of from 40 seconds to 100 seconds under ambient conditions.

### Embodiment 36

The method of embodiment 35, wherein the organic and aqueous compositions display a phase disengagement time of from 60 seconds to 90 seconds under ambient conditions.

### Embodiment 37

The method of any one of embodiments 1-36, wherein the presence of discrete filler reduces entrainment of the organic composition in the aqueous composition by at least 10 percent relative to that observed in absence of the discrete filler under ambient conditions.

### Embodiment 38

The method of embodiment 37, wherein the entrainment of the organic composition is reduced by at least 30 percent relative to that observed in absence of the discrete filler under ambient conditions.

### Embodiment 39

The method of embodiment 38, wherein the entrainment of the organic composition is reduced by at least 60 percent relative to that observed in absence of the discrete filler under ambient conditions.

### Embodiment 40

The method of any one of embodiments 1-39, wherein the discrete filler reduces turbidity of the aqueous composition associated with entrained organic composition by at least 10 percent relative to that observed in absence of the discrete filler under ambient conditions.

### Embodiment 41

The method of embodiment 40, wherein the turbidity is reduced by at least 30 percent relative to that observed in absence of the discrete filler under ambient conditions.

### Embodiment 42

The method of embodiment 41, wherein the turbidity is reduced by at least 60 percent relative to that observed in absence of the discrete filler under ambient conditions.

### Embodiment 43

The method of any one of embodiments 1-42, wherein separating the organic and aqueous compositions results in entrained aqueous composition in the organic composition in an amount of up to 1000 ppm.

### Embodiment 44

The method of embodiment 43, wherein separating the organic and aqueous compositions results in entrained aqueous composition in the organic composition in an amount of up to 500 ppm.

### Embodiment 45

The method of embodiment 44, wherein separating the organic and aqueous compositions results in entrained aqueous composition in the organic composition in an amount of up to 40 ppm.

### Embodiment 46

The method of embodiment 45, wherein separating the organic and aqueous compositions results in an equilibrium organic composition entrainment in the aqueous composition of up to 1000 ppm under ambient conditions.

### Embodiment 47

The method of embodiment 46, wherein the equilibrium organic composition entrainment in the aqueous composition is up to 300 ppm under ambient conditions.

### Embodiment 48

The method of embodiment 47, wherein the equilibrium organic composition entrainment in the aqueous composition is up to 10 ppm under ambient conditions.

### Embodiment 49

Polymeric fibers for use as the discrete filler in the method of any one of embodiments 1-48.

### Embodiment 50

The polymeric fibers of embodiment 49, wherein the polymeric fibers are provided in an oxime-based extractant present in the organic composition.

### Embodiment 51

The polymeric fibers of embodiment 49, wherein the polymeric fibers are provided in a carrier solvent present in the organic composition.

### Embodiment 52

The polymeric fibers of embodiment 49, wherein the polymeric fibers are provided in the aqueous composition.

### Embodiment 53

An extraction composition comprising: an organic composition comprising an extractant; and a discrete, insoluble filler dispersed in the organic composition.

### Embodiment 54

The extraction composition of embodiment 53, wherein the extractant is an oxime-based extractant.

### Embodiment 55

The extraction composition of embodiment 53 or 54, wherein the organic composition further comprises a carrier solvent, the extractant being dissolved in the carrier solvent.

### Embodiment 56

The extraction composition of any one of embodiments 53-55, wherein the discrete filler comprises polymeric fibers.

### Embodiment 57

The extraction composition of embodiment 56, wherein the polymeric fibers are selected from the group consisting of: polyester fibers, nylon fibers, 4-methylpentene-1 based polyolefin fibers, polyethylene fibers, and polypropylene fibers.

### Embodiment 58

The extraction composition of any one of embodiments 53-57, wherein the polymeric fibers are present in the organic composition in an amount of from 0.05 percent to 2 percent by weight based on the weight of the organic composition.

### Embodiment 59

The extraction composition of embodiment 58, wherein the polymeric fibers are present in the organic composition in an amount of from 0.075 percent to 1.5 percent by weight based on the weight of the organic composition.

### Embodiment 60

The extraction composition of embodiment 59, wherein the polymeric fibers are present in the organic composition in an amount of from 0.1 percent to 1 percent by weight based on the weight of the organic composition.

### Embodiment 61

The extraction composition of any one of embodiments 56-60, wherein the polymeric fibers have a median diameter of from 1 micrometer to 100 micrometers.

### Embodiment 62

The extraction composition of embodiment 61, wherein the polymeric fibers have a median diameter of from 3 micrometers to 50 micrometers.

### Embodiment 63

The extraction composition of embodiment 62, wherein the polymeric fibers have a median diameter of from 5 micrometers to 30 micrometers.

### Embodiment 64

The extraction composition of any one of embodiments 56-63, wherein the polymeric fibers have a median length of from 100 micrometers to 10000 micrometers.

### Embodiment 65

The extraction composition of embodiment 64, wherein the polymeric fibers have a median length of from 500 micrometers to 5000 micrometers.

### Embodiment 66

The extraction composition of embodiment 65, wherein the polymeric fibers have a median length of from 100 micrometers to 3000 micrometers.

### Embodiment 67

The extraction composition of any one of embodiments 56-66, wherein the polymeric fibers are surface functionalized by corona, flame, or plasma treatment.

### Embodiment 68

The extraction composition of any one of embodiments 56-66, wherein the polymeric fibers are bi-component fibers comprising a shell of a first composition disposed around a core of a second composition.

### Embodiment 69

The extraction composition of any one of embodiments 54-61, wherein the oxime-based extractant comprises a ketoxime.

### Embodiment 70

The extraction composition of embodiment 69, wherein the ketoxime has the chemical structure

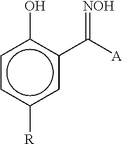

wherein A is selected from C₆H₅ and CH₃ and R is selected from C₁₂H₂₅ and C₉H₁₉.

### Embodiment 71

The extraction composition of any one of embodiments 54-70, wherein the oxime-based extractant comprises an aldoxime.

### Embodiment 72

The extraction composition of embodiment 71, wherein the aldoxime has the chemical structure

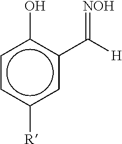

wherein R′ is selected from C₁₂H₂₅ and C₉H₁₉.

### Embodiment 73

The extraction composition of embodiment 71 or 72, further comprising a long chain alcohol modifier.

### Embodiment 74

The extraction composition of any one of embodiments 54-73, wherein the oxime-based extractant comprises a mixture of one or more ketoximes and one or more aldoximes.

### Embodiment 75

The extraction composition of any one of embodiments 55-74, wherein the carrier solvent comprises an aliphatic hydrocarbon, aromatic hydrocarbon, or mixture thereof.

### Embodiment 76

The extraction composition of embodiment 75, wherein the aliphatic hydrocarbon comprises a paraffin, cycloparaffin, or derivative thereof.

### Embodiment 77

The extraction composition of any one of embodiments 54-76, wherein the oxime-based extractant is present in an amount of from 1 percent to 30 percent by weight based on the weight of the organic composition.

### Embodiment 78

The extraction composition of embodiment 77, wherein the oxime-based extractant is present in an amount of from 5 percent to 25 percent by weight based on the weight of the organic composition.

### Embodiment 79

The extraction composition of embodiment 78, wherein the oxime-based extractant is present in an amount of from 10 percent to 20 percent by weight based on the weight of the organic composition.

### Embodiment 80

The extraction composition of any one of embodiments 53-79, further comprising an aqueous composition.

### Embodiment 81

The extraction composition of embodiment 80, wherein the aqueous composition is a sulfuric acid solution.

### Embodiment 82

The extraction composition of embodiment 81, wherein the sulfuric acid solution has a pH of from 1.1 to 2.5.

### Embodiment 83

The extraction composition of embodiment 82, wherein the sulfuric acid solution has a pH of from 1.4 to 2.

### Embodiment 84

The extraction composition of embodiment 83, wherein the sulfuric acid solution has a pH of from 1.6 to 1.8.

### Embodiment 85

The extraction composition of any one of embodiments 80-84, wherein the organic composition and aqueous composition collectively form an oil-in-water emulsion.

### Embodiment 86

The extraction composition of embodiment 85, wherein the organic composition and aqueous composition have an organic:aqueous ratio of from 0.2:1 to 1:1 by volume.

### Embodiment 87

The extraction composition of embodiment 86, wherein the organic composition and aqueous composition have an organic:aqueous ratio of from 0.7:1 to 1:1 by volume.

### Embodiment 88

The extraction composition of embodiment 87, wherein the organic composition and aqueous composition have an organic:aqueous ratio of from 0.9:1 to 1:1 by volume.

### Embodiment 89

A solvent extraction apparatus comprising: a mixing tank with the extraction composition of any one of embodiments 50-81 received therein, the mixing tank provided with an impeller to agitate the extraction composition; and a settling basin in communication with the mixing tank and comprising an inlet to receive the extraction composition from the mixing tank and an outlet.

### Embodiment 90

The apparatus of embodiment 89, wherein the settling basin further comprises one or more baffles located adjacent the outlet for segregating the organic composition from the aqueous composition as the extraction composition flows through the settling basin.

### Embodiment 91

The apparatus of embodiment 89 or 90, wherein the outlet has a configuration for discharging organic composition segregated from the extraction composition from the settling basin.

### Embodiment 92

The apparatus of any one of embodiments 89-91, wherein the settling basin further comprises one or more porous structures located between the inlet and the one or more baffles, the one or more porous structures having a configuration to coalesce droplets of the organic composition flowing through the settling basin.

### Embodiment 93

A hydrometallurgical method comprising: placing an acid or base in contact with a mineral bearing ore to obtain a pregnant leach solution; mixing a solvent extraction organic with the pregnant leach solution to provide an organic composition dispersed in an aqueous composition, respectively; separating the organic and aqueous compositions using the method of any one of embodiments 1-48 to provide a loaded organic composition; and contacting the loaded organic composition with a stripping solution to remove metal ions from the loaded organic composition.

### Embodiment 94

The method of embodiment 93, wherein the stripping solution comprises a strong sulfuric acid.

### Embodiment 95

The method of embodiment 94, wherein the strong sulfuric acid has a concentration of from 100 grams per liter to 200 grams per liter.

### Embodiment 96

The method of embodiment 95, wherein the strong sulfuric acid has a concentration of from 140 grams per liter to 170 grams per liter.

### Embodiment 97

The method of embodiment 96, wherein the strong sulfuric acid has a concentration of from 155 grams per liter to 165 grams per liter.

### Embodiment 98

The method of embodiment 93-97, further comprising electrolytically plating the metal ions in the stripping solution onto a cathode to obtain elemental metal.

### Embodiment 99

The method of any one of embodiments 93-98, wherein the metal ions are copper ions.

### Examples

Objects and advantages of this disclosure are further illustrated by the following non-limiting examples, but the particular materials and amounts thereof recited in these examples, as well as other conditions and details, should not be construed to unduly limit this disclosure.

Unless otherwise noted, all parts, percentages, ratios, etc. in the Examples and the rest of the specification are by weight.

These following abbreviations are used in the examples: v=volume, g=gram, h=hour, min=minute, sec=seconds, mm=millimeter, nm=nanometers, v=volume, rpm=revolutions per minute, NTU=nephelometric turbidity unit, ppm=parts per million, NM=not measured, and N/A=not applicable.

### Materials

Copper Sulfate, anhydrous (98%), was obtained from Alfa Aesar.
Iron Sulfate Pentahydrate was obtained from Pfaltz & Bauer.
Sulfuric Acid (50% v/v) was obtained from Alfa Aesar.
N-Hexane, spectrophotometric grade, was obtained from Alfa Aesar.
“LIX 84-I,” a ketoxime based complexing reagent was obtained from BASF Corporation, Tucson, Ariz., under the trade designation “LIX 84-I.”
“ORFOM SX 80,” a kerosene based solvent, was obtained from Conoco Phillips, Houston, Tex., under the trade designation “ORFOM SX 80.”
“Lurol F4897B” was obtained from Goulston Technologies, Inc., under the trade designation “Lurol F4897B.”
“Polylactic Acid,” a polylactic acid resin, was obtained from Natureworks, Minnetonka, Minn., under the trade designation “Ingeo Biopolymer 6100D.”
“Glass Fiber” was obtained from PPG Fiberglass, Cheswick, Pa., under the trade designation “Chopvantage HP 3270.”
“Glass Bubbles” were obtained from 3M under the trade designation “iM30K-N”
“Polyethylene Powder” a linear low density polyethylene resin, was obtained from ExxonMobil, Spring, Tex. under the trade designation “LL 1002.09.”
“Talc” was obtained from Imerys USA under the trade designation “Luzenac HAR T84.”
“Invista 8602,” a polyester resin, was obtained from Invista, under the trade designation “Invista 8602.”
“3766 PP,” a polypropylene resin, was obtained from Total, under the trade designation “3766 PP.”
“TPX,” a 4-methylpentene-1 based polyolefin resin, was obtained from Mitsui Chemicals, under the trade designation “TPX.”
“Nylon 6,6,” a nylon 6,6 fiber, was obtained in nominal diameters and lengths provided in Table 1, from Minifibers, Johnson City, Tenn.; trade designations are provided in Table 1 below. Nominal diameters of nylon 6,6 fibers were determined by scanning electron microscopy.
“Polyethylene,” fibrillated high density polyethylene fibers, were obtained from Minifibers, Johnson City, Tenn. Fibers with a diameter of 5 μm were obtained under the trade designation
“ESS2F” and fibers with a diameter of 20 μm were obtained under the trade designation “E990F.”
“Acrylic” was obtained from Minifibers, Johnson City, Tenn., under the trade designation “ACSTD-150RR-0650.”
“Rayon Fiber” was obtained from Minifibers, Johnson City, Tenn., under the trade designation “RAFLT-0454RR-0350.”

TABLE 1

| | Nominal | Length | Trade |
|---|---|---|---|
| Example | Diameter (μm) | (mm) | Designation |
| EX-6 | 11 | 3.175 | NYT66- |
| | | | 0102RR-0300 |
| EX-7 | 11 | 6.53 | NYT66- |
| | | | 0102RR-0600 |
| EX-8 | 19.2 | 6.35 | NYT66- |
| | | | 0302RR-0600 |
| EX-9 | 19.2 | 12.7 | NYT66- |
| | | | 0302RR-1200 |
| EX-10 | 27 | 6.35 | NYT66- |
| | | | 0602RR-0600 |

### Method for Extruding Fibers

The polypropylene, polyester, polylactic acid and TPX fibers were manufactured at 3M on a bi-component fiber spinning line from Hills Inc. from their respective resin pellets. The line consists of two 1.9 cm single screw extruders, a radiant heated compartment, three draw zones (four godets) and a winder. The fibers produced were single component fibers. The fibers were produced in a tow of 165 filaments from a 300 μm diameter orifice. The stable throughput rates per extruder were 0.9 to 6.8 kg/hr, depending on the density and molecular weight of the material. The fibers were coated with a sizing agent (10% (v/v) Lurol F4897B in water) prior to being wound on the winder. Subsequently the fibers were cut on a DM&E 20 Series Tow Cutter with a 0.635 cm Length Cutter Reel.

The resins, lengths and diameters of the fibers extruded by the above method are provided in Table 2 below. The materials, lengths and diameters of the other discrete fillers evaluated in comparatives C-1 through C-5 and examples EX-1 through EX-13 are also provided in Table 2. The diameter and length of polyethylene powder and talc provided in Table 2 are nominal values estimated from scanning electron micrographs.

TABLE 2

| | Discrete Filler | | | | |
|---|---|---|---|---|---|
| Comparative | | | Diameter | Length | Aspect |
| or Example | Material | Washed | (μm) | (mm) | Ratio |
| C-1 | Glass Fiber | N | 10 | 4.5 | 450 |
| C-2 | Glass Bubbles | N | 10 to 19 | 0.010 to | 1 |
| | | | | 0.019 | |
| C-3 | Polyethylene | N | 200 | 0.4 | 2 |
| | Powder | | | | |
| C-4 | Talc | N | 1 | 0.01 | 10 |
| C-5 | Rayon Fiber | N | 20.6 | 3.175 | 154 |
| EX-1 | Polylactic Acid | Y | 15 | 6.35 | 423 |
| EX-2 | Polyester | Y | 15 | 6.35 | 423 |
| EX-3 | Polyester | Y | 30 | 6.35 | 212 |
| EX-4 | Polypropylene | Y | 15 | 6.35 | 423 |
| EX-5 | Polypropylene | Y | 30 | 6.35 | 212 |
| EX-6 | Nylon 6,6 | Y | 11 | 3.175 | 289 |
| EX-7 | Nylon 6,6 | Y | 11 | 6.35 | 577 |
| EX-8 | Nylon 6,6 | Y | 19.2 | 6.35 | 192 |
| EX-9 | Nylon 6,6 | N | 19.2 | 12.7 | 385 |
| EX-10 | Nylon 6,6 | Y | 27 | 6.35 | 96 |
| EX-11 | Polyethylene | Y | 5 | 0.6 | 120 |
| EX-12 | Polyethylene | N | 20 | 2 | 100 |
| EX-13 | TPX | N | 30 | 6.35 | 212 |
| EX-14 | Acrylic | N | 42.8 | 6.35 | 148.4 |

### Method for Washing Chopped Polymeric Fibers

First, 5 g of a chopped polymeric fiber with a measured weight, diameter, and length were weighed in a dish on an analytical scale. Then the weighed filler was placed in a large jar affixed to a metal stand using a chain ring clamp. 700 mL of de-ionized water was added to the jar. An overhead lab mixer with a plastic, radial impeller was fastened to the metal stand above the jar and the impeller was lowered into the jar to a distance approximately 3 cm from the bottom. The mixer was turned on to 500 rpm for approximately 10 min so that the fibers were dispersed in the water.

After approximately 10 min, the jar was lowered while the mixer was spinning to prevent fibers from settling on the top of the impeller as the impeller exited the solution. The jar was detached from the chain ring clamp. The fibers were separated from the mixture by vacuum filtration, including a final rinse of collected fibers with de-ionized water. The fibers were placed in an open beaker to air dry at ambient temperature in a fume hood or at 60° C. in a convection oven.

When the fibers were no longer moist to the touch, gentle mechanical agitation was used to break apart fibers that agglomerated during the washing and drying process.

Method for Measuring Phase Disengagement Time. Entrainment, and Turbidity

Strip Aqueous Phase was prepared by adding 88.4 g copper sulfate and 160 g sulfuric acid to a 1 L glass flask and diluting to 1 L with de-ionized water, resulting in a copper concentration of 35 g/L.

Synthetic Pregnant Leach Solution (SPLS) was prepared by adding 15.2 g copper sulfate, 4.4 g ferrous sulfate, and approximately 2 mL sulfuric acid (50% v/v) to a 1 L glass flask and diluting to 1 L with de-ionized water, resulting in a copper concentration of 6 g/L, an iron concentration of 1 g/L, and a pH of 2.

SX reagent was prepared by making a 20% (v/v) solution of LIX 84-I in ORFOM SX 80. In order to load the SX reagent with a baseline concentration of copper, 400 mL of SX reagent was mixed with 400 mL Strip Aqueous Phase in a separatory funnel. The phases were allowed to separate before the SX reagent was removed from the vessel for use in measurements.

Phase disengagement time was measured using a cylindrical glass mixing vessel with a take-off valve attached to the bottom wall. The walls of the cylinder included four baffles evenly spaced around the circumference of the inner wall and protruding approximately 1 cm into the interior space. The vessel was fitted to an IKA model RW20 digital overhead mixer (IKA Works, Inc., Wilmington, N.C.) with a chain ring clamp and a 1.75 inch diameter slotted, polypropylene impeller a 10 cm stainless steel shaft was fitted to the mixer with the impeller positioned approximately three cm from the inner surface of the bottom wall. To the vessel was added 400 ml of SPLS and 200 ml of SX reagent. Also added, optionally, were desired amounts of chopped polymeric fiber. The contents of the vessel were agitated by operating the IKA mixer at 2,000 rpm for 3 min. The disengagement time was recorded as the time required after the end of the agitation step for the SX reagent organic phase to disengage from the SPLS aqueous phase, with a clear interface observed between the two phases. At 5 min from the end of the agitation step, two samples of the SPLS were removed from the cylinder through the take-off valve: a 100 mL sample was placed in a glass vial for measuring entrainment and a 30 mL sample was placed in a glass cuvette for measurement of turbidity.

The entrainment of SX reagent in the 100 mL sample was determined by the following procedure. 25 mL of n-hexane was added to the vial containing the entrainment sample. The vial was capped and mixed with a Cole-Parmer vortex mixer for approximately 1 min. After 2 min after the end of mixing, a 10 mL sample of the n-hexane phase was withdrawn by pipette and transferred to a cuvette. An absorption spectrum was measured with a Hach DR3900 Spectrophotometer. Absorption peaks with wavelengths in the range of 324 to 330 nm, compared to a calibration curve constructed from absorption peaks for known concentrations of LIX 84-I in n-hexane, was used to calculate entrainment as the amount of LIX 84-I extracted from the 100 mL sample into the n-hexane phase.

The turbidity of the 30 mL sample was measured in a Hanna HI 88713 turbidimeter and reported in Nephelometric Turbidity Units (NTU). The sample was then returned to the glass vessel for further use.

For comparatives C1 through C5 and examples EX-1 through EX-14 listed in Table 3 below, control measurements of disengagement time, turbidity and entrainment were made by following the procedure provided above but with no discrete filler added. The average and standard deviation of the disengagement time, turbidity and entrainment for these control measurements are provided in Table 3 below and referred to as “Control Average.” For all comparatives and examples listed in Table 3 below, the disengagement time, turbidity and entrainment were measured after addition of discrete filler by following the procedure provided above; these results are provided in Table 3 below and indicated as “1^{st} Trial.” For some comparatives and examples, the measurements of turbidity and entrainment were repeated after refilling the glass vessel with approximately 100 mL of SPLS to make up for the volume of SPLS removed for the first turbidity and entrainment measurements; these results are provided in Table 3 below and indicated as “2^{nd} Trial.” After the measurements for each comparative and example were complete, the following steps were taken to prepare the apparatus for measurement of another comparative or example: the SPLS was drained from the glass vessel through the take-off valve into a graduated cylinder, sufficient SPLS was added to the graduated cylinder to return the volume of SPLS to 400 mL, discrete filler was removed from the SX reagent by vacuum filtration of the SX reagent, the glass vessel and impeller were cleaned with acetone, rinsed with water, and dried in air.

The material, dimensions, and washed status of discrete fillers added to the vessel for measurements of phase disengagement time, entrainment and turbidity for comparatives and examples are provided in Table 2 above. When discrete fillers were optionally added to the cylinder for these measurements, they were added at a loading of 0.30% of the organic phase by weight. The results of the phase disengagement time, entrainment, and turbidity measurements for the comparatives and examples are provided in Table 3 below.

TABLE 3

| | | | | Amount of | Amount of |
|---|---|---|---|---|---|
| | | Turbidity - | Turbidity - | Entrainment | Entrainment |
| Exam- | | 1st Trial | 2nd Trial | (ppm) - 1st | (ppm) - 2nd |
| ple | PDT (sec) | (NTUs) | (NTUs) | Trial | Trial |
| Control | 66 ± 6.9 | 355 ± | NM | 362 ± 56.9 | NM |
| Average | | 65.7 | | | |
| C-1 | 65 | 330 | NM | 380 | NM |
| C-2 | 80 | 1016 | NM | 323 | NM |
| C-3 | 55 | 350 | NM | 457 | NM |
| C-4 | <20 | 821 | NM | 609 | NM |
| C-5 | 60 | 330 | NM | 380 | NM |
| EX-1 | 140 | 168 | NM | 220 | NM |
| EX-2 | 85 | 93.3 | 58.9 | 163 | 134 |
| EX-3 | 85 | 115 | 78.7 | 181 | 153 |
| EX-4 | 60 | 250 | NM | 302 | NM |
| EX-5 | 90 | 91.5 | 78.7 | 149 | 143 |
| EX-6 | 85 | 119 | 98 | 199 | 176 |
| EX-7 | 70 | 116 | 103 | 211 | 188 |
| EX-8 | 70 | 103 | 104 | 172 | 162 |
| EX-9 | 120 | 149 | NM | 158 | NM |
| EX-10 | 80 | 109 | 79.6 | 173 | 157 |
| EX-11 | 90 | 77.1 | 38.8 | 169 | 96 |
| EX-12 | 180 | 52.4 | 44.2 | 99 | 97 |
| EX-13 | 110 | 76.9 | 49 | 136 | 102 |
| EX-14 | 100 | 99 | 101 | 160 | 191 |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

What is claimed is:

1. A method of separating immiscible organic and aqueous compositions, the method comprising:
co-dispersing the organic composition and the aqueous composition, wherein the organic composition comprises a dispersed, discrete, insoluble filler comprising polymeric fibers; and
separating under gravity the organic and aqueous compositions into respective upper and lower layers, wherein the insoluble filler remains in the organic composition.

2. The method of claim 1, further comprising dispersing the discrete, insoluble filler in the organic composition prior to co-dispersing the organic composition and the aqueous composition.

3. The method of claim 1, wherein the polymeric fibers are present in the organic composition in an amount of from 0.05 percent to 2 percent by weight based on the weight of the organic composition.

4. The method of claim 1, wherein the polymeric fibers have a median diameter of from 1 micrometer to 100 micrometers.

5. The method of claim 1, wherein the polymeric fibers have a median aspect ratio of from 200 to 1000.

6. The method of claim 1, wherein the organic composition is a solvent extraction organic for a hydrometallurgical process.

7. The method of claim 6, wherein the solvent extraction organic comprises an oxime-based extractant dissolved in a carrier solvent.

8. The method of claim 7, wherein the aqueous composition is a sulfuric acid solution.

9. (canceled)

10. An extraction composition comprising:
an organic composition comprising an extractant; and
a discrete, insoluble filler dispersed in the organic composition, wherein the discrete filter comprises polymeric fibers.

11. The extraction composition of claim 10, wherein the extractant is an oxime-based extractant.

12. The extraction composition of claim 10, wherein the organic composition further comprises a carrier solvent, the extractant being dissolved in the carrier solvent.

13. (canceled)

14. The extraction composition of claim 10, wherein the polymeric fibers are selected from the group consisting of: polyester fibers, nylon fibers, 4-methylpentene-1 based polyolefin fibers, polyethylene fibers, and polypropylene fibers.

15. The extraction composition of claim 10, wherein the polymeric fibers are surface functionalized by corona, flame, or plasma treatment.

16. The extraction composition of claim 10, wherein the polymeric fibers are bi-component fibers comprising a shell of a first composition disposed around a core of a second composition.

17. (canceled)

18. A hydrometallurgical method comprising:
placing an acid or base in contact with a mineral bearing ore to obtain a pregnant leach solution;
mixing a solvent extraction organic with the pregnant leach solution to provide an immiscible organic composition dispersed in an aqueous composition, respectively;
separating the immiscible organic and aqueous compositions to provide a loaded organic composition; and
contacting the loaded organic composition with a stripping solution to remove metal ions from the loaded organic composition;
wherein separating the immiscible organic and aqueous compositions comprises using the method of separating immiscible organic and aqueous compositions of claim 1.

19. The method of claim 1, wherein the polymeric fibers are selected from the group consisting of: polyester fibers, nylon fibers, 4-methylpentene-1 based polyolefin fibers, polyethylene fibers, and polypropylene fibers.

20. The method of claim 1, wherein the polymeric fibers are surface functionalized by corona, flame, or plasma treatment.
